(19) United States
(12) Patent Application Publication
(10) Pub. No.: US 2008/0302475 A1
(43) Pub. Date: Dec. 11, 2008

(54) METHODS AND APPARATUS FOR APPYING APLIQUES

(75) Inventor: Joshua Peyser, Great Neck, NY (US)

Correspondence Address: KATTEN MUCHIN ROSENMAN LLP, 575 MADISON AVENUE, NEW YORK, NY, 10022-2585, US

(73) Assignee: MV SPORT, Bay Shore, NY (US)

(21) Appl. No.: 12/163,169

(22) Filed: Jun. 27, 2008

Related U.S. Application Data
(63) Continuation of application No. 11/320,170, filed on Dec. 28, 2005.

(51) Int. Cl. B32B 38/04

(52) U.S. Cl. 156/263

(57) ABSTRACT

Methods and apparatus for creating decorative multi-layer appliqué patterns for garments or other items are disclosed. In some aspects, the invention includes cutting a first pattern out of a first material to form a bottom layer, cutting a composite of the first pattern and a second pattern out of a second material to form a top layer, and affixing the layers to an item. Numerous other aspects are included.

### BACKGROUND OF THE INVENTION

1. Field of Invention

The present invention relates generally to the field of garment and decorative item manufacturing. More specifically, the present invention is related to applying appliqués to garments and other items.

2. Discussion of Prior Art

It has been known to employ various types of decorative and informational insignias and monograms on various articles of clothing. It is common to find caps, shirts, sweaters and jackets bearing team designations, university letters, company designations, and identification marks of individuals. One common method of applying these indicia have been by means of patches or appliqués which may be sewn on or adhesively secured.

There is a well know method often referred to as the “double tackle twill letter process” that is used to place letters on sweatshirts, t-shirts, other articles of clothing and the like. In such processes, a two-layer material may be used for the appliqué. Typically a first layer of the material is cut with the desired letters using computer controlled machinery that is pre-programmed with the pattern of the letters. The machine cuts out the letters for this layer. Thereafter, another layer is placed down and the machine cuts the pattern of letters for the top layer, typically the same letter but at a reduced size. The layers are then adhered to the article of clothing one smaller letter over the other letter.

Thus, for example, university letters such as NYU would appear on the sweatshirt with a first color outer trim from the bottom layer and a second, inner letter color from the slightly reduced in size top layer. The effect of the two layers is to create a border of one color and a letter of another color.

While these types of appliqués are typically stitched around the peripheries, other means of securing these letters in place may be used such as, pressure sensitive adhesive backing, heat activated adhesive, and other adhesive backings. Also, numerous different types of materials can be used for these letters.

### SUMMARY OF THE INVENTION

The present invention provides novel methods and apparatus for creating decorative multi-layer appliqué patterns for garments and/or other items. In a first aspect, the invention provides a method including the steps of cutting a first pattern out of a first material to form a bottom layer, cutting a different pattern out of a second material to form a top layer and affixing the layers to an item.

In a second aspect, the present invention provides a method including affixing a bottom layer of material to a garment wherein the bottom layer is shaped in a first pattern (e.g., letters), and affixing a top layer of material to the bottom layer wherein the top layer is shaped in a second pattern (e.g., an image). The top layer of material covers a smaller area than the bottom layer of material and the second pattern has a different shape than the first pattern but terminates at the boundaries of the first pattern of the bottom layer.

In a third aspect, the present invention provides a product including a garment, a bottom layer of appliqué attached to the garment, and a top layer of appliqué attached to the bottom layer. The bottom layer is shaped as a set of letters. The top layer is shaped as an intersection of the set of letters and an image such that the image appears to extend across, or flow between, at least a portion of the set of letters.

In a fourth aspect, the present invention provides a computer readable medium adapted to store instructions operable to direct an automated garment manufacturing system controller to cut a first pattern out of a first material to form a bottom layer, cut a second and different pattern out of a second material to form a top layer and thereafter the layers can be affixed to an article, typically clothing.

In a fifth aspect, the present invention provides an apparatus including a controller, a material cutter coupled to and operable by the controller, and a memory coupled to the controller and adapted to store instructions to cut a first pattern out of a first material to form a bottom layer, and cut a second and different pattern out of a second material to form a top layer.

It should be appreciated that in addition to two layers, other additional layers can be applied with each layer being cut into a different pattern than any of the other patterns. Furthermore, different colors for each of these layers can be included. Thereby multiple flowing patterns can be made over the base layer pattern.

### BRIEF DESCRIPTION OF THE DRAWINGS

FIG. 1 is a close-up perspective view of an item including an example multi-layer appliqué arrangement according to some aspects of the present invention.

FIG. 2 is a perspective view of a garment including a second example multi-layer appliqué arrangement according to some aspects of the present invention.

FIG. 3 is a close-up perspective view of an item including a third example multi-layer appliqué arrangement according to some aspects of the present invention.

FIG. 4 is a close-up perspective view of an item including a fourth example multi-layer appliqué arrangement according to some aspects of the present invention.

FIG. 5 is a close-up perspective view of an item including a fifth example multi-layer appliqué arrangement according to some aspects of the present invention.

FIG. 6 is a plan view of a sixth example multi-layer appliqué arrangement according to some aspects of the present invention.

FIG. 7A is a plan view of a bottom layer of an example appliqué arrangement according to some aspects of the present invention.

FIG. 7B is a plan view of the bottom layer of FIG. 7A with a cut pattern of an example appliqué arrangement according to some aspects of the present invention.

FIG. 7C is a plan view of a top layer on the example appliqué arrangement of FIG. 7B according to some aspects of the present invention.

FIG. 7D is a plan view of the top layer of FIG. 7C with a cut pattern of an example appliqué arrangement according to some aspects of the present invention.

FIG. 7E is a plan view of an example appliqué arrangement according to some aspects of the present invention.

FIG. 8 is a flowchart illustrating an example method according to some aspects of the present invention.

### DESCRIPTION OF THE PREFERRED EMBODIMENTS

While the present invention is illustrated and described in terms of specific preferred embodiments, the invention may be produced and practiced using many different configurations, forms and materials. There is depicted in the drawings, and will herein be described in detail, preferred embodiments of the invention, with the understanding that the present disclosure is to be considered as an exemplification of the principles of the invention and the associated functional specifications for its construction and practice, and is not intended to limit the invention to the embodiments illustrated. Those skilled in the art will envision many other possible variations within the scope of the present invention.

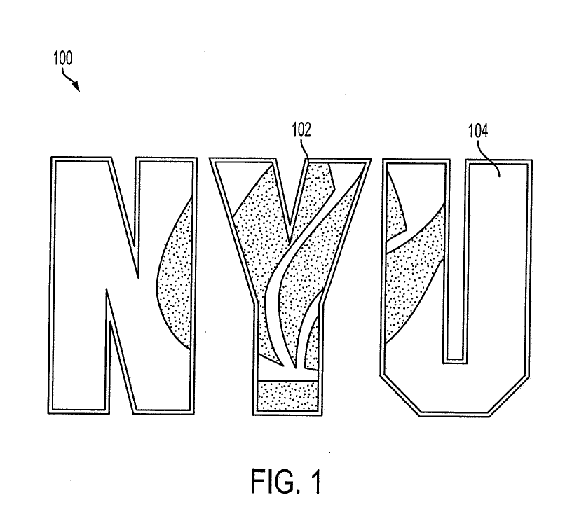

Referring to FIG. 1, the present invention provides methods for manufacturing multi-layer appliqué arrangements for garments or other items 100. The method enables the manufacture of a appliqué that incorporates two or more symbols or images into one design. A bottom layer of material 102 may be cut into a pattern, for example, that includes university initials (e.g., NYU). A top layer of material 104 may be cut into a composite (e.g., the intersection) of the university initials and a graphic image, for example, a torch. The different layers 102, 104 may be made of different materials (e.g., different fabric types, plastics, etc.) and may be different colors and/or shades.

Once the two layers 102, 104 have been cut, they may be aligned so that the top layer 104 is superimposed upon the bottom layer 102. The effect of the overlaying or superimposing of the top layer 104 on the bottom layer 102 is that both patterns are visible within the boundaries of the bottom layer. Other effects may be created using different color schemes and additional layers.

In the example depicted in FIG. 1, the top layer 104 is formed from a composite of the letter pattern and the torch image as indicated above. However, note that the letter pattern used for the top layer is actually smaller (e.g., a reduced size) than the letter pattern of the bottom layer 102. An effect of using a smaller letter pattern to combine or intersect with the torch image is to create an appearance of a border around the top layer 104 that is similar to the effect created by the conventional double tackle twill letter processes with using sized letters. However, in this case, by cutting out portions of the top layer, the appearance of the bottom layer will also show up to give the appearance of a second pattern, the torch extending across the letters.

The term “intersection” as used herein refers to an area of overlap that exists when two patterns are superimposed upon each other. The term is intended to convey a meaning that is analogous to the corresponding mathematical term used in set theory. For example, the intersection of two partially overlapping circles of the same size is a football shape. The intersection of a small circle entirely within a large circle is the small circle. Therefore, a composite of two patterns that is in the shape of the “intersection” of the two patterns will generally appear to be in the shape of the smaller of the two patterns but the shape will terminate at the boundary of the larger pattern. The present invention uses such shapes for the top layer of the appliqué.

The term “complement” as used herein refers to the negative or absence of material such as the material that remains once a pattern has been cut out of the material. As with the term intersection, the term complement is also intended to convey a meaning analogous to the corresponding mathematical term used in set theory.

With these meanings in mind, the shape of the top layer 104 may be described generally as the intersection of (1) the shape of the bottom layer 102 and (2) a second shape. In FIG. 1, the shape of the bottom layer 102 is the letters “NYU” and the second shape is a torch. Note that the described “intersection” for the top layer 104 may be made by cutting out a composite of the first shape, the NYU letters, and the second shape, the torch. In alternative embodiments, the first shape, i.e., the letters, may be cut from a sheet of material and then the second shape, i.e., the torch, may be cut from the first shape. In yet other alternative embodiments, instead of the second shape, the complement of the second shape may be used. In such cases, the shape of the top layer 104 may be described generally as the intersection of (1) the shape of the bottom layer 102 and (2) the complement of a second shape.

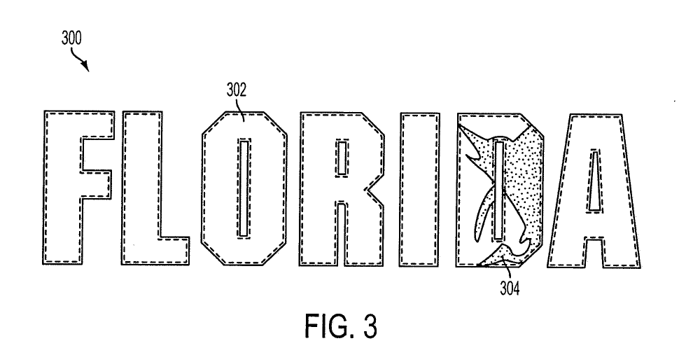

Note that, as shown in FIG. 1, the torch shape spans across, or flows between, all three of the NYU letters. In other alternative embodiments that will be described below (see, for example, the “D” in FIG. 3), the second shape, pattern, or image may be contained entirely within one letter or discrete element of the first shape. In such a case, the second shape may be both small enough and aligned so as to fit entirely within a discrete element of the first shape. When this is the case, the second shape is not altered by the boundaries of the first shape. If however, the second shape is either larger than the discrete element of the first shape and/or aligned such that the second shape extends beyond the edges of the discrete element of the first shape, according to the present invention, the second shape is cut to terminate at the boundaries of the first shape. However, it may continue the second shape on to subsequent elements of the first shape.

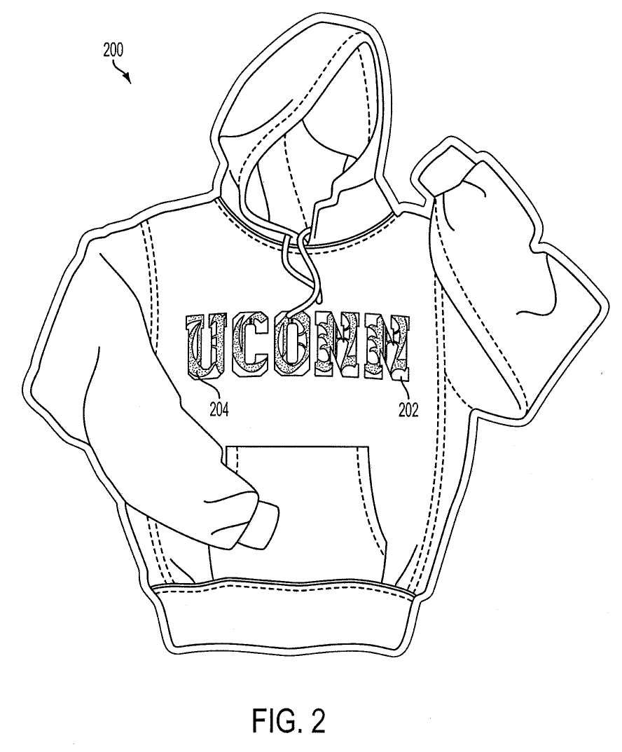

Turning to FIG. 2, a garment 200 includes another example appliqué according to the present invention. The bottom layer 202 is in the shape of block letters that spell out the University of Connecticut's initials: UCONN. The top layer 204 is in the shape of the intersection of the UCONN block letters and a second set of UCONN letters in a different, more elaborate font. Note that in this example, the top layer 204 includes a pattern that extends all the way to the edges of the block letter pattern of the bottom layer 202 and thus, unlike the appliqué arrangement of FIG. 1, there is no appearance of a border effect surrounding the letters of FIG. 2.

Turning to FIGS. 3 through 6, four examples of additional embodiments are depicted. FIG. 3 includes a bottom layer 302 that uses a light fabric in the shape of the word “FLORIDA” attached to the item 300. The top layer 304 includes a darker fabric in the shape of a swordfish superimposed on the letter “D” in FLORIDA. Note that the shape of the swordfish is trimmed to fit within the letter D. For example, the center cutout of the letter D is also cutout of the swordfish shape. In other words, the swordfish shape is intersected with the D shape to form the top layer 304 that is then aligned with the letter D of the bottom layer 302.

FIG. 4 includes a bottom layer 402 that uses a dark fabric in the shape of the university initials “NYU” attached to the item 400. The top layer 404 includes a lighter fabric in the shape of a horizontal rectangular bar that flows across the letters but trimmed to only include the portions of the bar that intersect with the letters NYU.

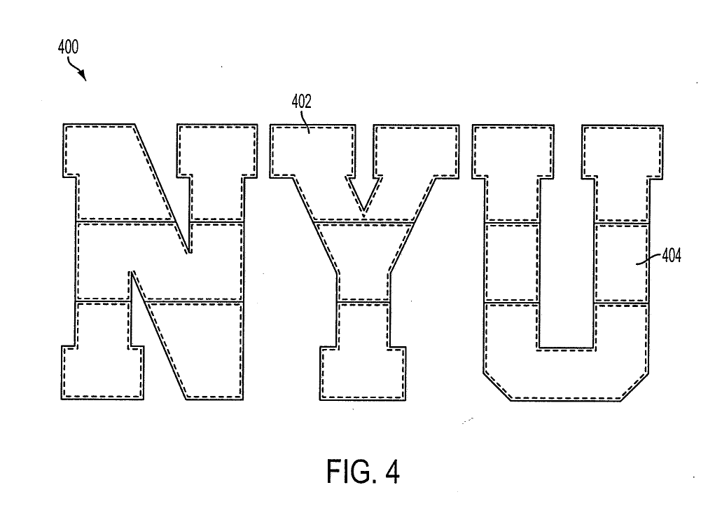

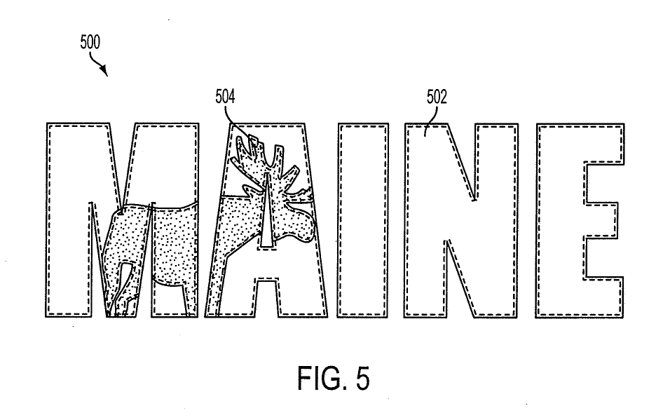

FIG. 5 includes a bottom layer 502 that uses a dark colored fabric in the shape of the word “MAINE” attached to the item 500. The top layer 504 includes a lighter colored fabric in the shape of an antelope on the letters “M” and “A” in MAINE. Note that the shape of the antelope is trimmed to fit within the letters M and A but extends or flows between the two letters. In other words, the top layer 504 is in the shape of the intersection of the letters (M and A) and the image of an antelope.

FIG. 6. includes a bottom layer 602 that uses a diagonal striped material in the shape of the letter “C”. The top layer 604 includes a polka dotted material in the identical shape of the letter C but with a diagonal bar cut out across the upper left portion of the letter. In other words, the top layer 604 is in the shape of the intersection of the letter C and the complement of a diagonal bar across the upper left portion of the letter.

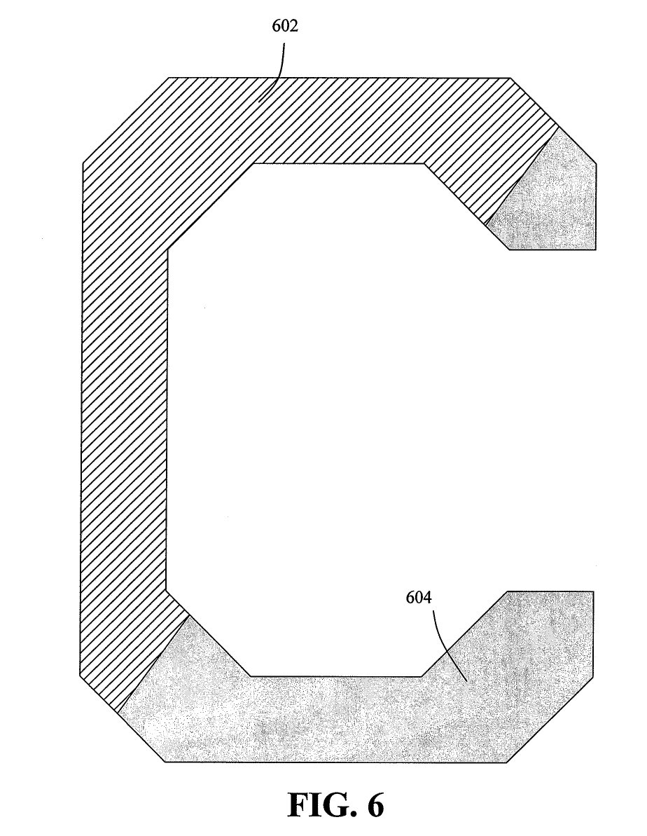

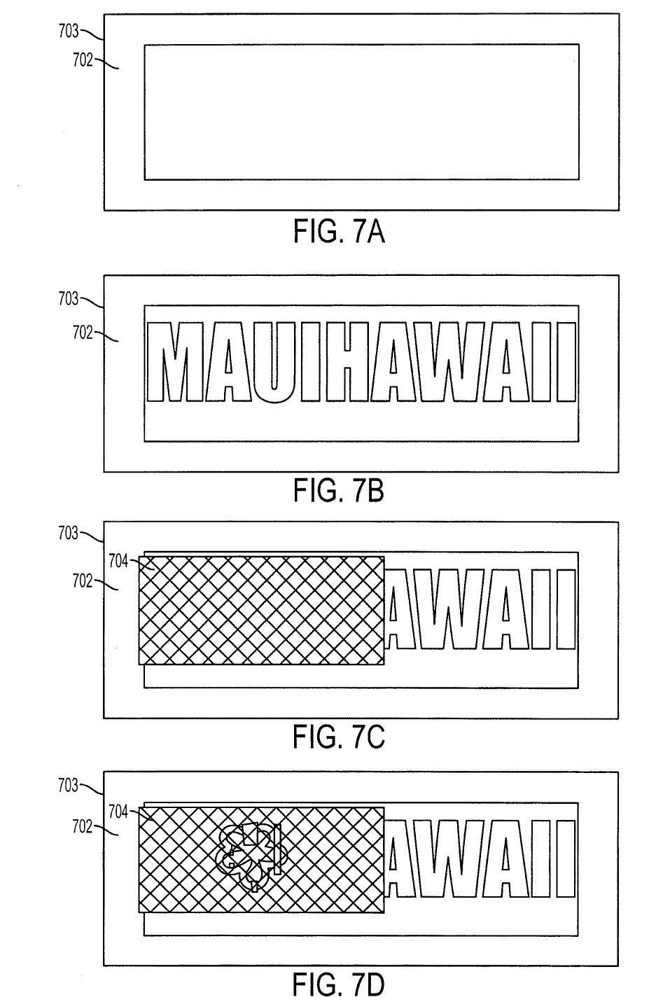

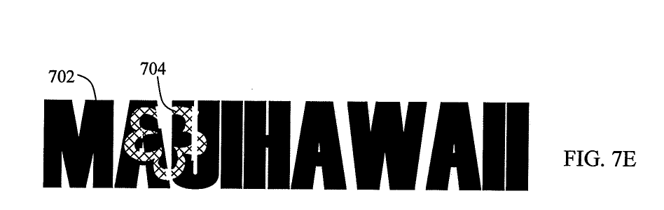

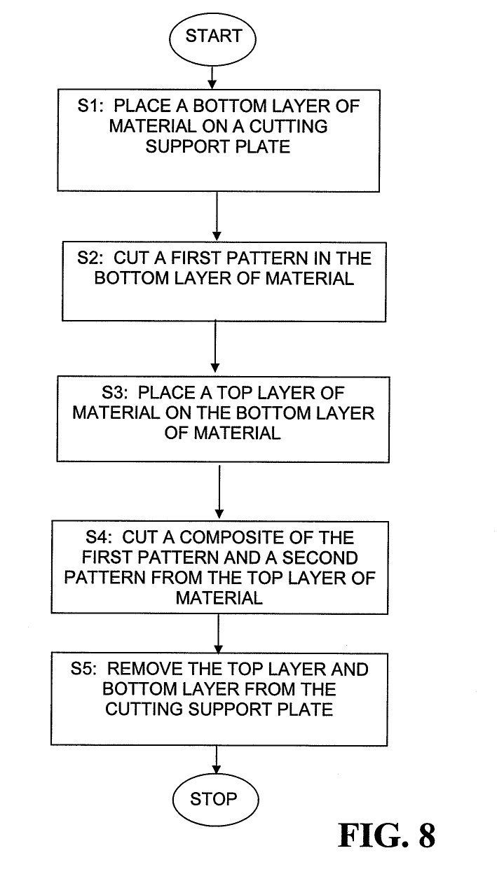

Turning now to FIGS. 7A through 7E and FIG. 8, an example method of the present invention will be described in more detail. Note that the described method is merely one example provided to illustrate the invention and that many variations and alternative methods are possible. Further, the various methods of the present invention may be implemented in whole or in part using a computer controlled, automated manufacturing system (e.g., fabric and/or material cutting and/or sewing/adhering machines as well as robotic and/or material handling/conveying/alignment machines). Instructions embodying the methods of the present invention may be stored in memories, computer disks, carrier wave signals, transmission lines, web servers, and/or any media or form that is accessible by a computer or manufacturing system controller. Thus, the present invention includes machines programmed to implement the methods of the present invention as well as computer readable media that are adapted to store computer or controller instructions embodying the methods of the present invention.

In Step S1, a bottom layer of material 702 is placed on a cutting support plate 703 as shown in FIG. 7A. The cutting support plate 703 is used with a material cutting machine to cut a layer of material as is known in the art. In Step S2, a first pattern (e.g., the letters “MAUIHAWAII”), is cut into the bottom layer of material 702. A representation of the results of Step S2 is shown in FIG. 7B.

In Step S3, a top layer of material 704 is placed over the bottom layer of material 702 as shown in FIG. 7C. Note that in practice the top layer of material 704 may cover the entire bottom layer 702. Here, for clarity however, only a portion of the bottom layer 702 is covered. In Step S4, a second pattern, such as a flower, is cut in the top layer of material 704. The second pattern lays within the boundaries of the first pattern. A representation of the results of Step S4 is shown in FIG. 7D.

In Step S5, the portion not including the pattern of the top layer 704 and the portions not included in the pattern (e.g., the letters) of the bottom layer 702 are removed from the cutting support plate 703 as shown in FIG. 7E. Thereafter, the letters with the pattern on them may be attached to a garment or other article.

The layers 702, 704 may be attached to a garment or other article using any of a number of standard appliqué attachment techniques. In some embodiments, the letters are placed and an outlined pattern is stitched on the garment corresponding to the outline pattern (e.g., MAUIHAWAII). Thereafter, the letters are placed onto the garment and that same embroidery machine that stitched the outline for ease of placement may now embroider the stitching around the periphery of each of the letters with a fabric selected for the periphery sewing. Additionally, the same embroidery machine will also stitch around the flower patterned material of the top layer 704. While stitching is indicated, it should be appreciated that the layers 702, 704 could alternatively or additionally be adhered to the article using adhesive, glue, or attached in any practicable way.

### CONCLUSION

The present invention includes an appliqué process in which a top layer that is a composite of two patterns is applied onto a bottom layer that is shaped as one of the two patterns. The composite of the two patterns forming the top layer may be the intersection of the two patterns. The method includes placing layers over layers, with one pattern of one layer overlying another pattern of another layer. Additionally, the method includes creating a appliqué design in which the overlay pattern flows or extends across the underlying pattern such that there is not a one to one relationship of the overlying pattern to the particular letter that is under it. The overlaying pattern flows from letter to letter.

Further the present invention also includes a process in which a bottom layer not only appears around the border of the top layer as in the typical prior art double tackle twill letter process, but also may appear through a cutout pattern in the top layer. The bottom layer may be cut to the overall letter or design, and the top layer may be cut not with the identical shape as the bottom, but with cut out portions so that a second design will appear over the bottom as part of the cutouts forming the top layer.

Based on these concepts, numerous variations are possible. For example, a single letter having a design within it may be created. Alternatively, a design may flow from letter to letter so that the total overall design appears as a result of interconnecting the segments from multiple, separate letters. Additionally, more than two layers may be utilized whereby multicolor images may be created by aligning relative cut out portions between layers.

Systems and methods have been shown in the above described embodiments for applying appliqué s. While various preferred embodiments have been disclosed and described, it will be understood that there is no intent to limit the invention by such disclosure, but rather, it is intended to cover all modifications and alternate constructions falling within the spirit and scope of the invention, as defined in the appended claims. For example, the present invention should not be limited by size, materials, patterns, colors, textures, or specific manufacturing techniques.

1-33. (canceled)

34. A method of forming a compound pattern on a garment comprising the steps of:
cutting a first pattern in a first material layer, such that the pattern includes a plurality of individual elements;
overlaying the first layer with a second material layer;
cutting a second pattern into the second material layer, said second pattern extending across at least a portion of two of the individual elements of the first pattern, said second pattern follows the contours of the first layer to the extent that the second layer does not extend beyond a border of an individual element of the first layer; and
affixing the first and second layers on a garment.

35. The method of claim 34 wherein the first material layer and the second material layer are different colors.

36. The method of claim 34 wherein the first material layer and second material layer are different.

37. The method of claim 34 wherein the first pattern includes letters.

38. The method of claim 34 wherein the second pattern includes a graphic image.

39. The method of claim 1 wherein the second pattern includes a negative cutout of a graphic image.

40. The method of claim 34 wherein the second pattern has a shape such that when superimposed upon the first pattern, a third pattern is visible.

41. The method of claim 34 further comprising the steps of:
cutting a third pattern out of a third material layer; and
affixing the third layer to the first and second layers.

42. The method of claim 40 wherein the third material is different than the first and second material layers.

43. The method of claim 40 wherein the second pattern is a negative image of the third pattern.
